(19) United States
(12) Patent Application Publication
(10) Pub. No.: US 2021/0194262 A1
(43) Pub. Date: Jun. 24, 2021

(54) CHARGE AND DISCHARGE CONTROL SYSTEM, CHARGE AND DISCHARGE CONTROL METHOD, AND PROGRAM

(71) Applicant: NEC Corporation, Tokyo (JP)

(72) Inventor: Kazuo OGURA, Tokyo (JP)

(21) Appl. No.: 16/076,168

(22) PCT Filed: Feb. 10, 2017
(86) PCT No.: PCT/JP2017/004888

§ 371 Date: Aug. 7, 2018

(30) Foreign Application Priority Data
Feb. 12, 2016 (JP) 2016-024426

(51) Int. Cl. H02J 7/00

(52) U.S. Cl. CPC H02J 7/00302; H02J 3/004; H02J 7/00712

(57) ABSTRACT

The charge and discharge control system includes: a power generation apparatus that supplies power to load equipment or supplies surplus power to a system side; a storage battery that is capable of accumulating surplus power from the power generation apparatus; and a control part that receives a power generation amount suppression instruction and transfers the power generation amount suppression instruction to the power generation apparatus. When the control part receives the power generation amount suppression instruction, if free capacity of the storage battery is less than a predetermined value, the control part transfers the power generation amount suppression instruction to the power generation apparatus.

### CROSS-REFERENCE TO RELATED PATENT

This application is a National Stage Entry of International Application No. PCT/JP2017/004888, filed Feb. 10, 2017, which claims priority from Japanese Patent Application No. 2016-024426, filed Feb. 12, 2016, The entire contents of the above-referenced applications are expressly incorporated herein by reference.

### REFERENCE TO RELATED APPLICATION

The present invention is based upon and claims the benefit of the priority of Japanese patent application No. 2016-024426, filed on Feb. 12, 2016, the disclosure of which is incorporated herein in its entirety by reference thereto.

### FIELD

The present invention relates to a charge and discharge control system, a charge and discharge control method, and a program. In particular, it relates to a charge and discharge control system, a charge and discharge control method, and a program that controls charge and discharge of a storage battery in which power generated by a power veneration apparatus is accumulated.

### BACKGROUND

PTL 1 discloses a stand-alone power supply system requiring a reduced installation cost. Specifically, the stand-alone power supply system according to PTL 1 calculates demand prediction data about a load apparatus and power generation output prediction data about a natural energy power generation apparatus by using weather prediction data. If the stand-alone power supply system predicts that a storage battery will be charged beyond its maximum charge power from the demand prediction data and the power generation output prediction data, the stand-alone power supply system suppresses the output of the power generation of the natural energy power generation apparatus. If the stand-alone power supply system predicts that a storage battery will be discharged beyond its maximum discharge power from the demand prediction data and the power generation output data, the stand-alone power supply system suppresses the power consumption of an adjustment load. PTL 1 points out that this configuration eliminates the need to separately arrange an adjustment power supply such as a diesel engine and the need to increase the capacity of a storage apparatus. Namely, PTL 1 points out that the installation cost is reduced.

PTL 2 discloses a photovoltaic power generation system capable of suppressing system collapse in a power system and effectively using generated power. According to PTL 2, this photovoltaic power generation system includes a solar cell module 1 that performs photovoltaic power generation and a measurement unit 5 that measures the generated power. The photovoltaic power generation system also includes, as electric equipment that can consume the generated power, an electric water heater 4 that boils water with the supplied power. In this photovoltaic power generation system, when the measurement unit 5 acquires output suppression information that instructs output suppression and determines that the electric water heater 4 can perform its boiling operation, the measurement unit 5 cancels the output suppression of the generated power and calculates the power consumed by the electric water heater 4.

As discussed in NPLs 1 and 2, recent years have seen a rapid increase in use of distributed power resources (power generation apparatuses) using renewable energy such as energy generated by solar power, which is also called photovoltaics (PV) or solar photovoltaics, or energy generated by wind power. However, this increase causes more surplus power to reversely flow to the power system, making the power system unstable.

As indicated in NPLs 1 and 2, while free output control on a day-to-day basis is currently performed for 30 days per year, discussion is underway regarding future implementation of output suppression control per time unit. However, contact by early evening on the previous day or calendar control as indicated on slide page 10 of NPL 1 is not enough for the implementation of the output suppression control per time unit. In addition, according to NPL 1, it is planned that the output control will be performed on small photovoltaic power generation equipment for household use or the like in the future.

### CITATION LIST

### Patent Literature (PTL)

PTL 1: Japanese Patent Kokai Publication No. JP2013-176234A

PTL 2: Japanese Patent Kokai Publication No. JP2015-106937A

### Non-Patent Literature (NPL)

NPL 1: Kyushu Electric Power Co., Inc., February, 2015, “Explanatory Material regarding Resumption of Answering Questions about Application for Connection to Renewable Energy Generation Equipment in Kyushu”, [online], [searched on Dec. 10, 2015], Internet <URL:http://www.kyuden.co.jp/library/pdf/notice/q27hfv5k.pdf> NPL 2: Tohoku Electric Power Co., Inc., January, 2015, “(Attachment 1) Concept of Application of New Output Control Rules regarding Renewable Energy Generation Equipment based on Amendment of Ministerial Ordinance”, [online], [searched on Dec. 10, 2015], Internet <URL:http://www.tohoku-epco.co.jp/news/normal/_icsFiles/afieldfile/2015/01/23/1188918b1.pdf>

### SUMMARY

The following analysis has been made by the present inventor. As in PTL 1, there are cases in which a storage battery charged with surplus power is connected to a PV system. These cases also have a problem in that, when the output suppression control in the above NPLs 1 and 2 is given, a PCS (a power conditioning system) also called a power conditioner that controls the output of a PV cannot perform, based on the free capacity of the storage battery with which power storage can be performed, efficient output suppression and the power storage that avoids the output suppression.

It is an object of the present invention to provide: a charge and discharge control system that can contribute to improvement of the efficiency of a charge and discharge control system operation in an environment in which output suppression of a power generation apparatus is performed; a charge and discharge control method; and a program.

According to a first aspect, there is provided a charge and discharge control system including a power generation apparatus that supplies power to load equipment or supplies surplus power to a system side. This charge and discharge control system further includes a storage battery that is capable of accumulating surplus power from the power generation apparatus. This charge and discharge control system further includes a control part that receives a power generation amount suppression instruction and transfers the power generation amount suppression instruction to the power generation apparatus. When the control part receives the power generation amount suppression instruction, if free capacity (or volume) of the storage battery is less than a predetermined value, the control part transfers the power generation amount suppression instruction to the power generation apparatus.

According to a second aspect, there is provided a control apparatus, which is connected to a power generation apparatus that supplies power to load equipment or supplies surplus power to a system side and a storage battery that is capable of accumulating surplus power from the power generation apparatus, receives a power generation amount suppression instruction, and transfers the power generation amount suppression instruction to the power generation apparatus, wherein, when the control part receives the power generation amount suppression instruction, if free capacity of the storage battery is less than a predetermined value, the control apparatus transfers the power generation amount suppression instruction to the power generation apparatus.

According to a third aspect, there is provided a charge and discharge control method, comprising: causing a control part in a charge and discharge control system including a power generation apparatus that supplies power to load equipment or supplies surplus power to a system side, a storage battery that is capable of accumulating surplus power from the power generation apparatus, and the control part that receives a power generation amount suppression instruction and transfers the power generation amount suppression instruction to the power generation apparatus to receive the power generation amount suppression instruction; and causing the control part to transfer, if free capacity of the storage battery is less than a predetermined value when the control part receives the power generation amount suppression instruction, the power generation amount suppression instruction to the power generation apparatus. This method is associated with a certain machine, which is the charge and discharge control system including the above power generation apparatus, storage battery, and control part.

According to a fourth aspect, there is provided a program, causing a computer constituting a control part in a charge and discharge control system including a power generation apparatus that supplies power to load equipment or supplies surplus power to a system side, a storage battery that is capable of accumulating surplus power from the power generation apparatus, and the control part that receives a power generation amount suppression instruction and transfers the power generation amount suppression instruction to the power generation apparatus to perform processing for: receiving the power generation amount suppression instruction; and transferring, if free capacity of the storage battery is less than a predetermined value when the control part receives the power generation amount suppression instruction, the power generation amount suppression instruction to the power generation apparatus. The program can be recorded in a computer-readable (non-transient) storage medium. Namely, the present invention can be embodied as a computer program product.

The meritorious effects of the present invention are summarized as follows.

The present invention can contribute to improvement of the efficiency of an operation of a charge and discharge control system in an environment in which output suppression of a power generation apparatus performed. Namely, the present invention can significantly improve the efficiency of an operation of a charge and discharge control system that receives a power generation amount suppression instruction.

### BRIEF DESCRIPTION OF DRAWINGS

FIG. 1 illustrates a configuration according to an exemplary embodiment of the present disclosure.

FIG. 2 illustrates an operation according to the exemplary embodiment of the present disclosure.

FIG. 3 illustrates another operation according to the exemplary embodiment of the present disclosure.

FIG. 4 illustrates an operational advantage according to the exemplary embodiment of the present disclosure.

FIG. 5 illustrates a configuration according to another exemplary embodiment of the present disclosure.

FIG. 6 illustrates a configuration according to another exemplary embodiment of the present disclosure.

FIG. 7 illustrates a configuration according to another exemplary embodiment of the present disclosure.

FIG. 8 illustrates a configuration of a charge and discharge control system according to a first exemplary embodiment of the present disclosure.

FIG. 9 is a functional block diagram illustrating a configuration example of a HEMS in the charge and discharge control system according to the first exemplary embodiment of the present disclosure.

FIG. 10 is a sequence diagram illustrating an operation in the charge and discharge control system according to the first exemplary embodiment of the present disclosure.

FIG. 11 is a sequence diagram illustrating an operation in a charge and discharge control system according to a second exemplary embodiment of the present disclosure.

FIG. 12 illustrates an operational advantage in the charge and discharge control system according to the second exemplary embodiment of the present disclosure.

FIG. 13 illustrates an operational advantage in the charge and discharge control system according to the second exemplary embodiment of the present disclosure.

FIG. 14 is a functional block diagram illustrating a configuration example of a HEMS in the charge and discharge control system according to the second exemplary embodiment of the present disclosure,

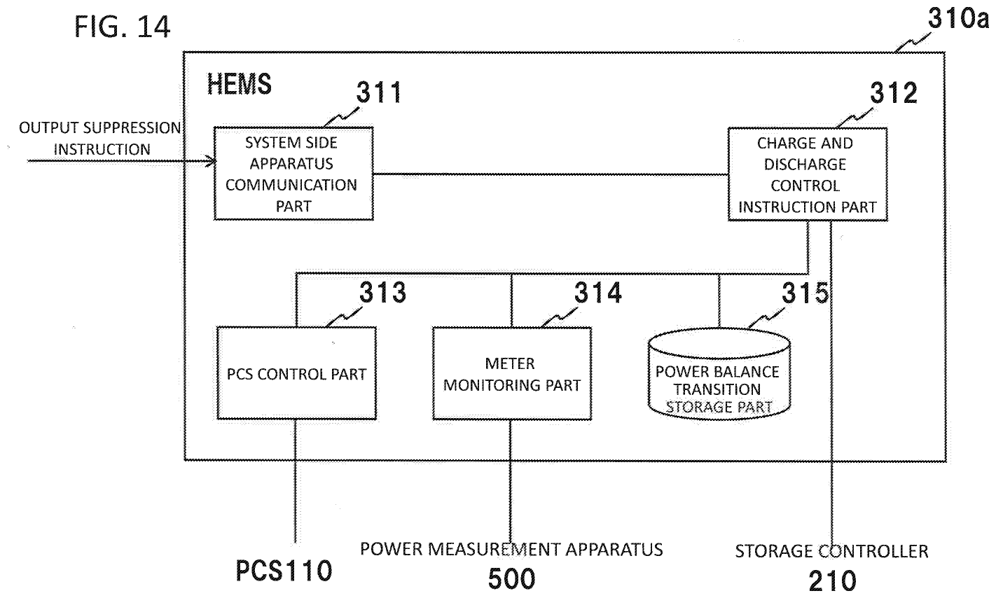

FIG. 15 illustrates a reference example relating to the present disclosure.

FIG. 16 illustrates a reference example relating to the present disclosure.

### PREFERRED MODES

First, an outline of an exemplary embodiment of the present disclosure will be described with reference to drawings. Reference characters in the following outline denote various elements for the sake of convenience and are used as examples to facilitate understanding of the present disclosure. Namely, the reference characters are not intended to limit the present disclosure to the illustrated modes. An individual connection line between blocks in a drawing or the like to which the following description refers signifies both one-way and two-way directions. An individual arrow schematically illustrates the principal flow of a signal (data) and does not exclude bidirectionality. In addition, although there are ports or interfaces at the connection points of the input and output of each block in the figures, they are omitted.

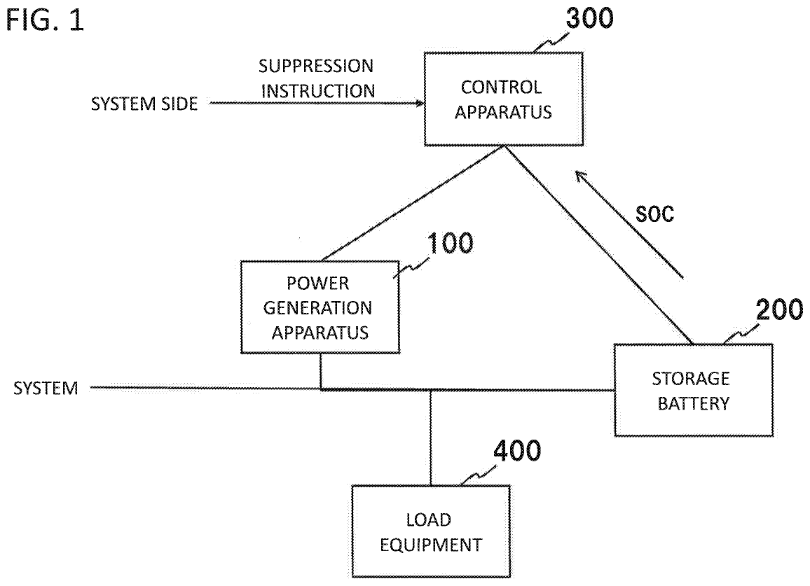

As illustrated in FIG. 1, an exemplary embodiment of the present disclosure can be realized by a charge and discharge control system including a power generation apparatus 100, a storage battery 200, a control apparatus 300, and load equipment 400. More specifically, the power generation apparatus 100 supplies power to the load equipment 400 or supplies surplus power to a system side. The storage battery 200 can accumulate surplus power from the power generation apparatus 100. The control apparatus 300 receives a power generation amount suppression instruction from an external apparatus or the like and transfers the power generation amount suppression instruction to the power generation apparatus 100. This “surplus power” indicates, of all the power generated by the power generation apparatus, the power beyond the power consumption of the load equipment,

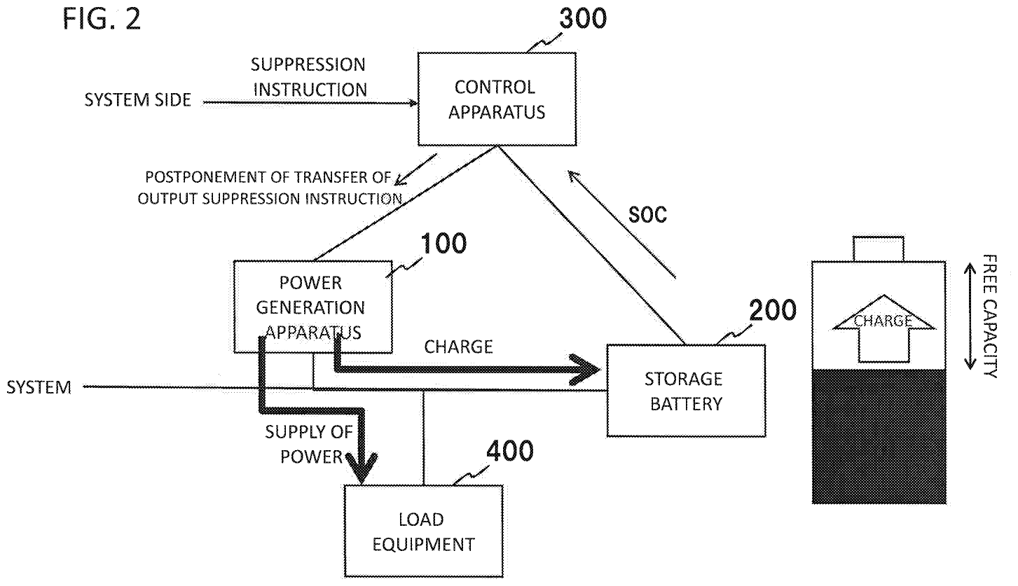

When the control apparatus 300 receives the power generation amount suppression instruction, the control apparatus 300 checks the SOC (State Of Charge) of the storage battery 200. If, as a result of the checking, the free capacity indicates a predetermined value or more, the control apparatus :300 shortens the suppression implementation period of the power generation apparatus 100 (postponement of transfer of output suppression instruction in die example in FIG. 2) and performs charge control on the storage battery in a period obtained by shortening the suppression implementation period.

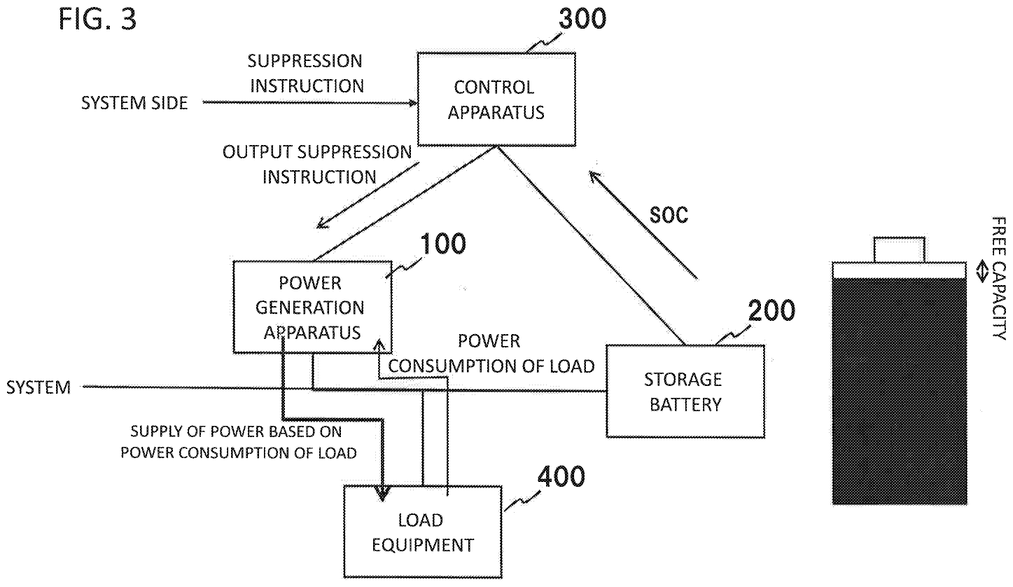

If, as a result of the charge control, the free capacity of the storage battery 200 indicates a value less than the predetermined value, the control apparatus 300 transfers the received power generation amount suppression instruction to the power generation apparatus 100, as illustrated in FIG. 3. In addition, if the power generation apparatus 100 has an output suppression function that uses the larger one of the output power (generated power permitted) based on a suppression instruction directly or indirectly given by the control apparatus 300 and the power consumed by the load equipment as the upper limit, the power generation apparatus 100 subsequently generates the larger one of the power consumed by the load equipment 400 and the generated power based on the power generation amount suppression instruction.

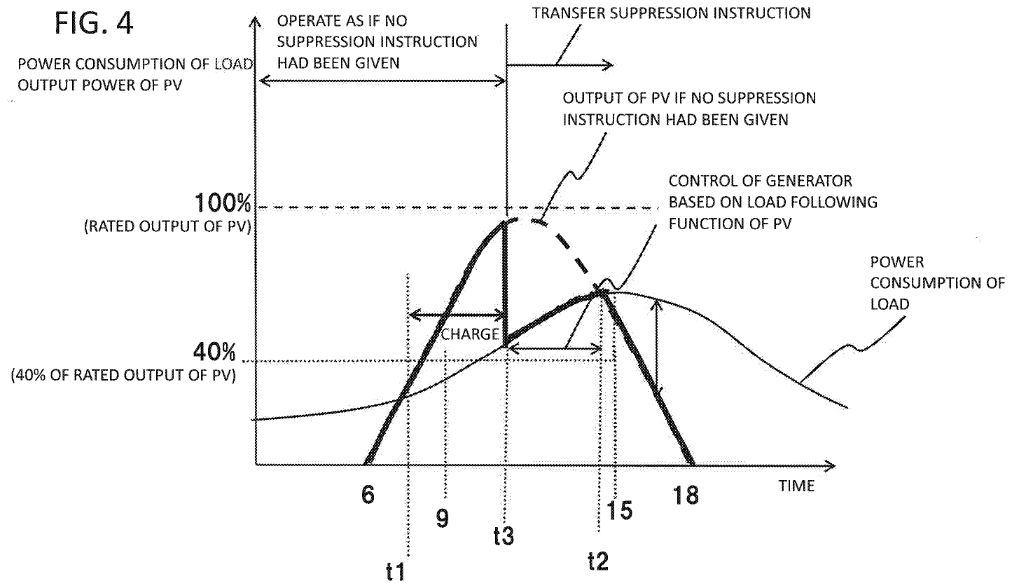

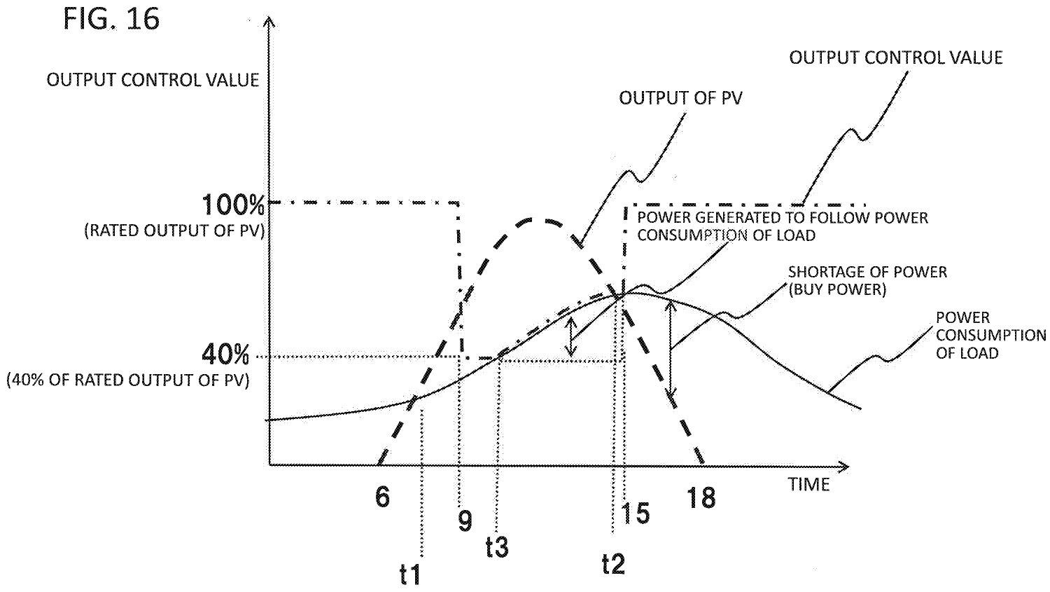

FIG. 4 illustrates change of the output of the charge and discharge control system that operates as described above. FIG. 4 illustrates an example in which the control apparatus 300 receives a suppression instruction indicating that the power generation amount needs to be suppressed to 40% of the rated output from 9 o'clock to 15 o'clock. Since surplus power starts to be generated at time t1, charging of the storage battery is started from this time on. Next, the control apparatus 300 receives an output suppression instruction at 9 o'clock. If the control apparatus 300 were a conventional control apparatus, the control apparatus 300 would instruct the power generation apparatus 100 to suppress its power generation amount at 9 o'clock (see FIG. 16). However, in the example in FIG. 4, the control apparatus 300 postpones the transfer timing of the power generation amount suppression instruction and continues the share control on the storage battery 200. By charging the storage battery 200 with the surplus power generated from the power generation apparatus 100 from 9 o'clock to time t3, it is possible to make it look as if the surplus power had been consumed by the load. Thus, even if the power generation apparatus 100 does not perform any output suppression, the output limit (the power consumption of the load) is not exceeded. Consequently, the storage battery 200 is charged from 9 o'clock to time t3. When the charging of the storage battery 200 is completed at time t3, the control apparatus 300 instructs the power generation apparatus 100 to suppress its power generation amount. Thereafter, when the power falls below 40% of the rated output or the power consumption of the load equipment, the power generation apparatus 100 starts to generate power to supplement the insufficiency (in the example in FIG. 4, since the power consumption of the load exceeds the output power of the PV from time t2 to 15 o'clock, the necessary power needs to be purchased or the storage battery needs to be discharged). As described above, by charging the storage battery in a period in which the output would be suppressed, the output suppression period can substantially be shortened, and the power that can be generated by the PV can effectively be used. In the above description, while the storage battery is charged with the surplus power from time t1 to time t3 at which the control apparatus 300 receives the output suppression instruction, the surplus power may be allowed to reversely flow to the power system to sell the surplus power to the system side.

In the examples in FIGS. 1 to 4, while the control apparatus 300 is independently arranged as a control part in the charge and discharge control system, a control part in the power generation apparatus 100 or the storage battery 200 may be configured to serve as the control part in the charge and discharge control system.

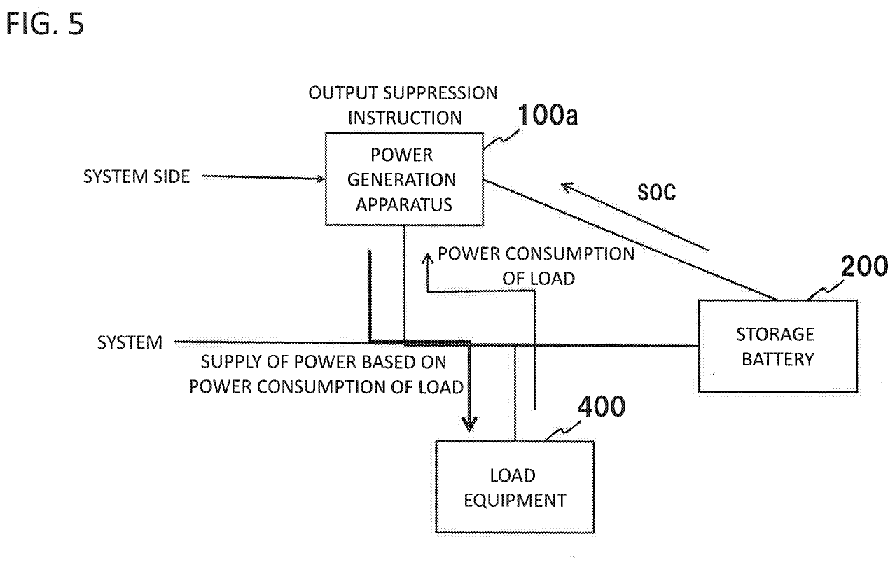

For example, as illustrated in FIG. 5, a control part of a power generation apparatus 100a may be allowed to operate as the control apparatus 300. In this case, based on the SOC of the storage battery 200, the power generation apparatus 100a shortens the power generation implementation period (for example, postponement of the implementation of the output suppression instruction), performs necessary power generation in a period obtained by shortening the suppression period, and instructs the storage battery 200 to perform charging. Upon completion of the charging, the power generation apparatus 100a generates the larger one of the power consumed by the load equipment 400 and the power generated based on the power generation amount suppression instruction.

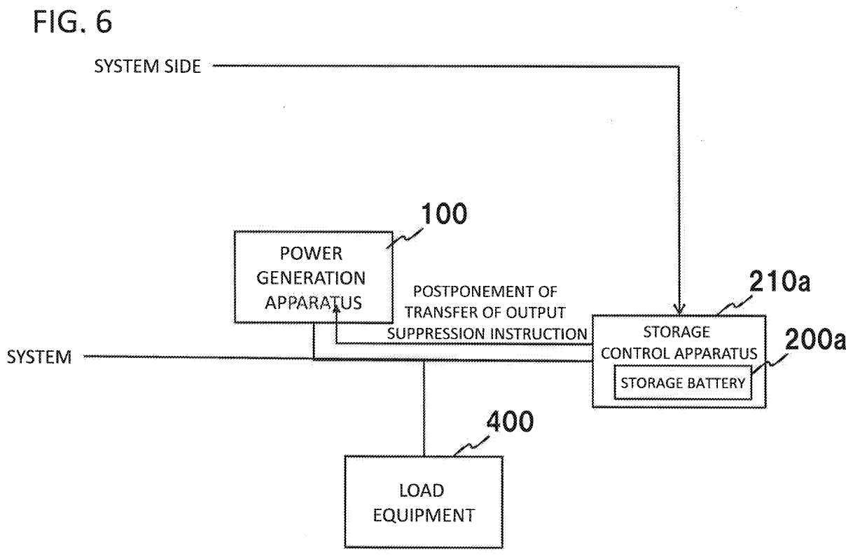

Likewise, as illustrated in FIG. 6, a storage control apparatus 210a including a storage battery 200a may be allowed to operate as the control apparatus 300. In this case, based on the SOC of the storage battery 200, the storage control apparatus 210a postpones the transfer timing of the suppression instruction to the power generation apparatus 100.

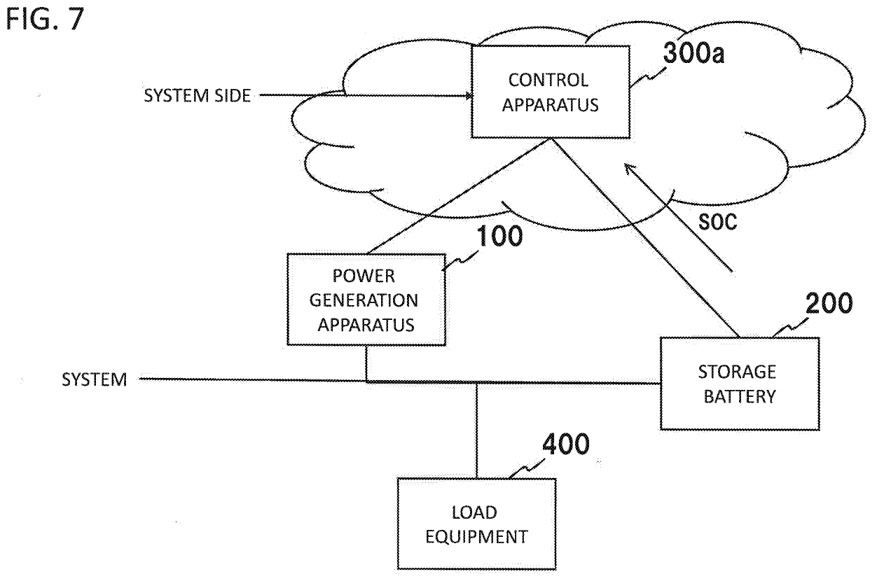

Likewise, as illustrated in FIG. 7, a control apparatus 300a may be arranged on a network. This control apparatus 300a may be a physical server or the like physically connected to a network. Alternatively, a service(s) corresponding to the control apparatus 300a may be provided by using a virtual server or a virtual network function established on a network by using virtualization technology or the like.

### First Exemplary Embodiment

Next, a first exemplary embodiment of the present disclosure will be described. Before the first exemplary embodiment is described, an operation performed when a PV equipment including a function (a load following function) of adjusting its output based on the power consumption of load receives an output suppression instruction will be described as a reference example.

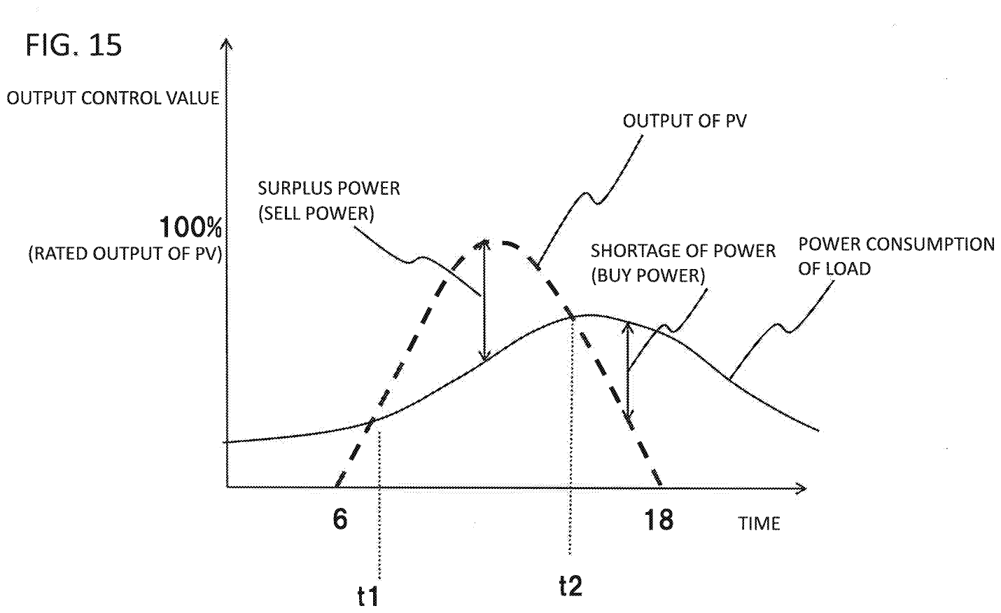

FIG. 15 illustrates the power generation amount of this kind of PV equipment and the power consumption of the load and the power balance therebetween. In FIG. 15, the portion where the output of the PV exceeds the power consumption of the load indicates the surplus power, namely, the power that can be sold. In the example in FIG. 15, after time t1, the power generation amount increases, and the surplus power starts to be generated. After the noon, as sunset approaches, while the power generation amount decreases, the power consumption of the load increases. After time t2, the power becomes insufficient, and power needs to be supplied from the system side.

For example, as illustrated in FIG. 16, if this PV equipment receives a suppression instruction for suppressing the output to 40% (the rated output is considered as 100%) from 9 o'clock to 15 o'clock, since the power generation amount exceeds the power consumption of the load from 9 o'clock to time t3, the generated power can be sold. More specifically, the power corresponding to the difference obtained by subtracting the power consumption of the load from the value corresponding to 40% of the rated output, which is the generated power permitted, can be sold. Thereafter, the power consumption of the load increases from time t3 to time t2 and exceeds the power generation amount after the suppression instruction is applied. Among various kinds of PV equipment, there is PV equipment including a PCS (a power conditioning system), which is also called a power conditioner, having a function (a load following function) of generating additional power by the amount corresponding to the difference between the power consumption of the load and the power generation amount after the suppression instruction is applied, in addition to the specified 40%. FIG. 16 illustrates an example of this kind of PV equipment including a PCS, which increases the output control value to follow the increase of the power consumption of the load.

When PV equipment includes a storage battery, the storage battery could not be charged sufficiently on a day when output suppression control as illustrated in FIG. 16 is performed, as seen from FIG. 16. If this happens, the user needs to purchase power in the evening or the like.

### Configuration According to First Exemplary Embodiment

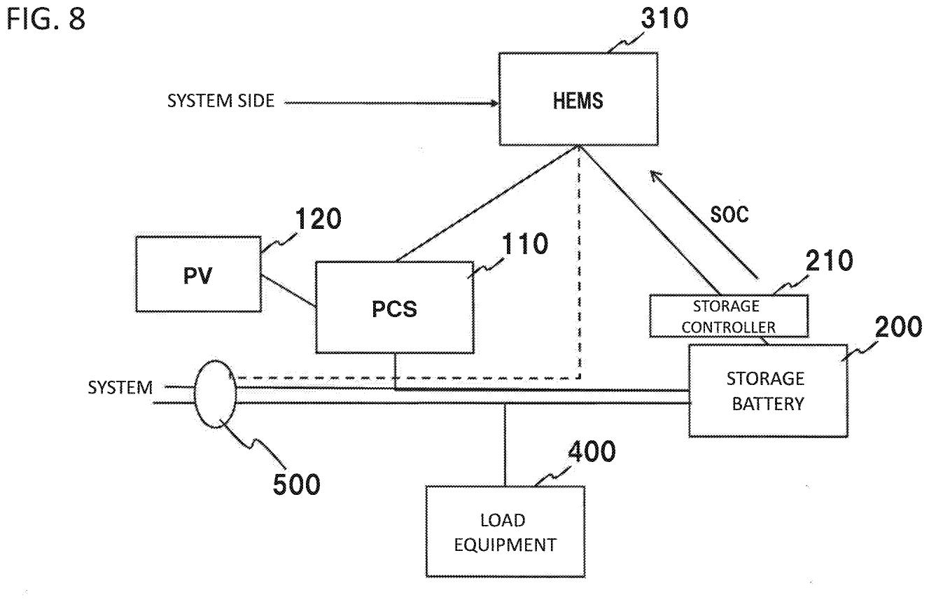

FIG. 8 illustrates a configuration of a charge and discharge control system according to. a first exemplary embodiment of the present disclosure. As illustrated in FIG. 8, the configuration includes a PCS 110 connected to a PV 120, a storage battery 200 connected to a storage controller 210, a HEMS 310, and load equipment 400.

The PV 120 is equipment called photovoltaics, solar photovoltaics, etc. and performs photovoltaic generation. The PCS (power conditioning system) 110 is equipment that converts DC power outputted from the PV 120 into AC power. The output from the PCS 110 is supplied to the system side, the load equipment 400, or the storage battery 200.

The storage controller 210 is equipment that controls charge and discharge of the storage battery 200. In addition, the storage controller 210 monitors the SOC of the storage battery 200 and supplies the SOC to the HEMS 310 as SOC (State Of Charge) information. Any one of various kinds of secondary battery such as a lithium-ion battery, a nickel-hydride battery, a lead battery, and a sodium-sulfur battery may be used as the storage battery 200. In addition, while a dedicated storage battery may be prepared as the storage battery 200, a storage battery mounted on an electric vehicle (EV) or a storage battery used for a household power storage system may be used as the storage battery 200.

The HEMS (Home Energy Management System) 310 is equipment that is connected to the PCS 110, the power measurement apparatus 500, a storage controller 210 and displays and controls information provided from these elements. Since the present exemplary embodiment assumes a household system, a HEMS is used. However, the HEMS 310 may be replaced by a BEMS (Building Energy Management System), a FEMS (Factory Energy Management System), or an EMS (Energy Management System), which is a general term for these systems, depending on the installation location. An operation of the HEMS 310 according to the present exemplary embodiment will be described in detail below.

The load equipment 400 is equipment that consumes power of a home electrical appliance or the like. The power measurement apparatus 500 includes a CT (current transformer) sensor, measures the difference between the output power of the PCS 110 and the power consumption of the load equipment 400, and supplies the difference to the HEMS 310. For example, heat pump equipment (a water heater or the like) that can collect thermal energy from the outside air by using power and store the collected thermal energy may be used as the load equipment 400. Alternatively, for example, a lifting pump that stores water as potential energy by using power may be used as the load equipment 400.

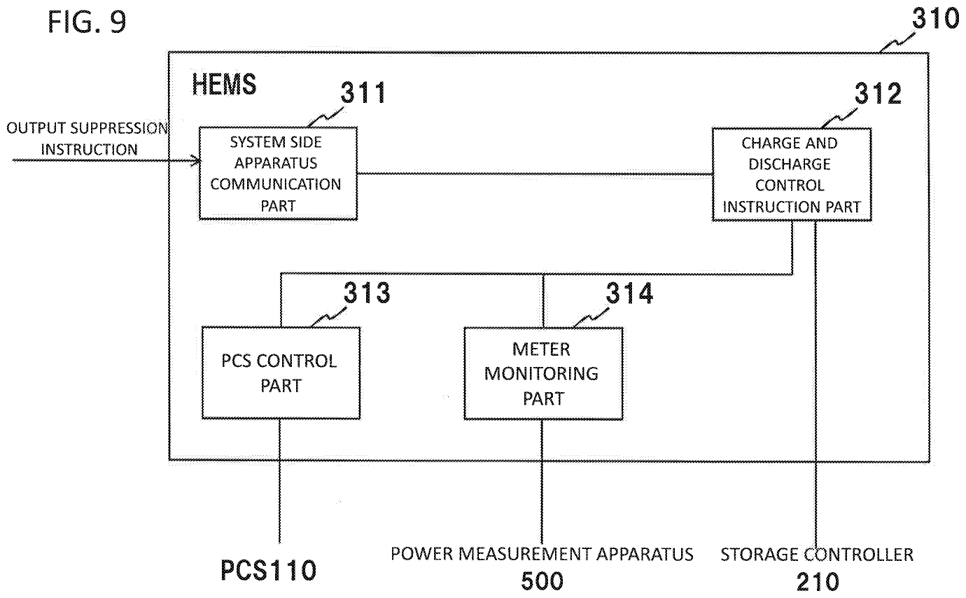

FIG. 9 is a functional block diagram illustrating a configuration example of the HEMS 310. As illustrated in FIG. 9, the HEMS 310 includes a system side apparatus communication part 311, a charge and discharge control instruction part 312, a PCS control part 313, and a meter monitoring part 314.

The system side apparatus communication part 311 communicates with a management server of an electric power company, the organization for cross-regional coordination of transmission operators (OCCTO), or the like in a predetermined method. Specifically, when the system side apparatus communication part 311 receives a power output suppression instruction from a management server of an electric power company or the OCCTO, the system side apparatus communication part 311 transfers the content of the instruction to the charge and discharge control instruction part 312. In addition, the system side apparatus communication part 311 transmits a reply such as an acknowledgement message (Ack) in response to the power output suppression instruction to the management server.

The PCS control part 313 is connected to the PCS 110 and supplies the current state information about the PCS to the charge and discharge control instruction part 312. In addition, when the PCS control part 313 receives an output suppression instruction from the charge and discharge control instruction part 312, the PCS control part 313 requests the PCS 110 to perform output suppression in accordance with the content of the output suppression instruction.

The meter monitoring part 314 receives the difference between the output power of the PCS 110 and the power consumption of the load equipment 400 from the power measurement apparatus 500 and supplies the difference to the charge and discharge control instruction part 312.

The charge and discharge control instruction part 312 is connected to these parts of the HEMS 310 and the storage controller 210.

When the charge and discharge control instruction part 312 receives a power output suppression instruction from the system side apparatus communication part 311, the charge and discharge control instruction part 312 operates as follows. First, the charge and discharge control instruction part 312 checks the SOC of the storage battery 200 received from the storage controller 210 and the presence or absence of surplus power received from the power measurement apparatus 500. If the free capacity of the storage battery 200 indicates a predetermined threshold or more and if there is surplus power, the charge and discharge control instruction part 312 shortens the suppression implementation period of the power generation apparatus 100 and charges the storage battery 200 with the power generated by the power generation apparatus 100 in a period obtained by the shortening the suppression implementation period. The present exemplary embodiment will be described assuming that the suppression implementation period is shortened by postponing the transfer timing of the output suppression instruction to the power generation apparatus 100.

The charge and discharge control instruction part 312 continuously checks the SOC of the storage battery 200 during the charge period. According to the present exemplary embodiment, when the storage battery 200 is fully charged, the charge and discharge control instruction part 312 stops the charging and transfers the output suppression instruction to the PCS 110 via the PCS control part 313.

When receiving the output suppression instruction, the PCS 110 suppresses the output of the power generation apparatus 100 in accordance with the output suppression instruction. During this suppression period, if the power consumption of the load equipment 400 exceeds the power generation amount in accordance with the output suppression instruction, the PCS 110 increases the output of the power generation apparatus 100 by the excess, to supplement the power consumption of the load equipment 400 (load following function).

An individual part (processing means) of the control apparatus 300 or the HEMS 310 illustrated in FIGS. 1 to 9 may be realized by storing the corresponding threshold described above in a memory of a computer constituting the corresponding apparatus and by causing a computer program to execute the corresponding processing such as comparison with the corresponding input value described above and transmission (transfer) of an instruction by using its hardware.

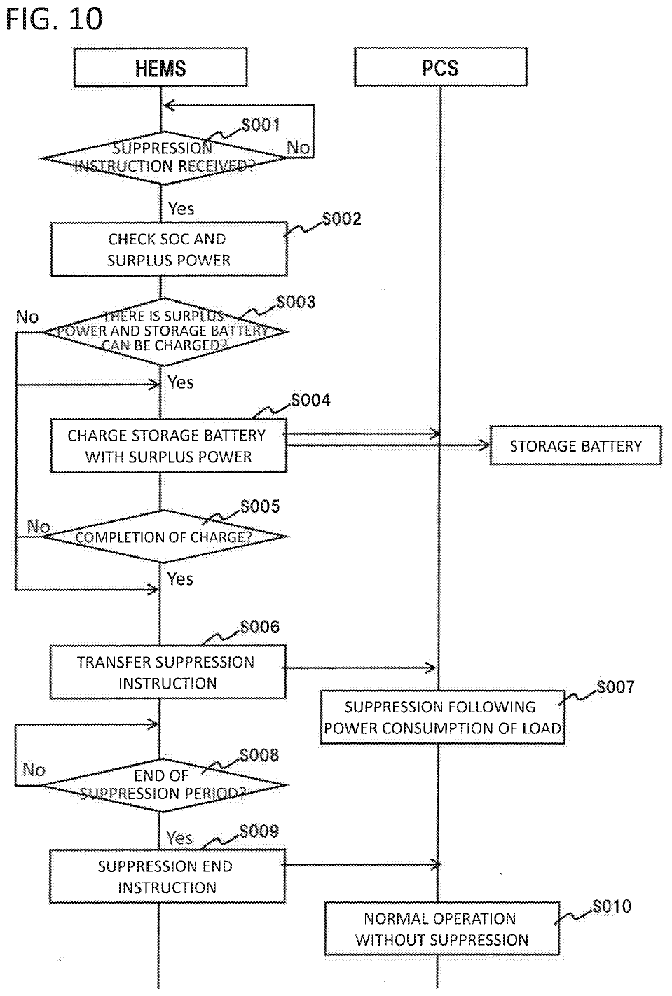

Next, an operation according to the present exemplary embodiment will be described in detail with reference to drawings. FIG. 10 is a sequence diagram illustrating an operation of the charge and discharge control system according to the first exemplary embodiment of the present disclosure. As illustrated in FIG. 10, first, if the HEMS 310 receives an output suppression instruction (Yes in step S001), the HEMS 310 checks the SOC of the storage battery 200 received from the storage controller 210 and the intrasystem power balance received from the power measurement apparatus 500 such as a CT sensor (step S002).

If, as a result of the checking, the HEMS 310 determines that there is surplus power and that the storage battery 200 can be charged (Yes in step S003), the HEMS 310 shifts to the charge mode and charges the storage battery 200 with the surplus power in a period obtained by shortening the output suppression instruction (step S004). Specifically, the HEMS 310 postpones the transfer of the output suppression instruction to the PCS 110 and instructs the storage controller 210 to charge the storage battery 200 with, of all the power generated by the power generation apparatus 100, the surplus power beyond the power consumption of the load apparatus 400. If the storage battery 200 itself has a function of performing charging based on the surplus power of the power generation apparatus 100 and if the function is already active, the HEMS 310 does not need to give any particular instruction to the storage controller 210. However, if the function is inactive for some reason, the HEMS 310 needs to instruct the storage controller 210 to resume the operation of the function. Depending on the amount of the surplus power, there are cases in which the rated power that can be received by the storage battery 200 is exceeded. in this case, for example, the HEMS 310 may instruct the storage controller 210 to charge the storage battery 200 with the maximum charge power, which is the rated power, and transfer the output suppression instruction to the PCS 110 (not illustrated). in this way, the output of the power generation apparatus 100 is adjusted in such a mariner that second surplus power (surplus power—maximum charge power) with which the storage battery 200 cannot be charged by the load following function of the PCS 110 reaches zero. Namely, even if the storage battery can be charged, if the surplus power exceeds the maximum charge power, which is the rated power that can be accepted by the storage battery 200, the output of the power generation apparatus 100 can be suppressed in such a manner that the second surplus power (surplus power maximum charge power) indicates zero. However, if the output power specified in accordance with a suppression instruction is larger than the adjusted output of the power generation apparatus 100, the output of the power generation apparatus 100 is adjusted to reach the specified output power.

During the charge mode, the HEMS 310 checks the SOC of the storage battery 200 (step S005). if the charge amount of the storage battery 200 indicates a predetermined threshold or more (Yes in step S005), the HEMS 310 stops the charge mode and transfers the output suppression instruction received in step S001 to the PCS 110 (step S006).

Subsequently, the PCS 110 performs the output suppression in accordance with the output suppression instruction. However, as described in the present exemplary embodiment, if the power consumption of the load equipment 400 exceeds the power generation amount in accordance with the output suppression instruction (after time t3 in FIG. 4), the PCS 110 performs the output suppression (the load following function) that follows the power demand of the load equipment 400 (step S007).

Subsequently, the HEMS 310 checks whether the end of the period (suppression period) specified by the output suppression instruction received in step S001 has arrived (step S008). If, as a result of the checking, the end of the suppression period has arrived, the HEMS 310 instructs the PCS 110 to end the output suppression (step S009).

Subsequently, the PCS 110 returns to an operational state without suppression (step S010).

As described above, according to the present exemplary embodiment, after receiving an output suppression instruction, the HEMS 310 does not instruct the PCS 110 to perform the output suppression immediately but allows the PCS 110 to perform its normal operation without suppression and allows the storage controller 210 to charge the storage battery 200 (see FIG. 4). In addition, the after the charging of the storage battery 200 is completed, since the PCS 110 performs the suppression control (the load following function) in accordance with the fluctuation of the demand of the load equipment 400, even when the output suppression causes insufficiency of the power, power does not need to be supplied from the system side as much as possible.

The above advantageous effect is more significant when the PCS 110 has a function of adjusting the output control value in such a manner that the increase of the load is followed as illustrated in FIG. 16. While the PCS 110 is following the load during an output suppression period, the PCS 110 is not allowed to sell power to the system side. Thus, the PCS adjusts the output so that power to be sold is not generated (however, specified output power, which is generated power permitted by a suppression instruction, can be sold to the system side). The storage controller 210 also has the adjustment function of charging the storage battery 200 with surplus power and preventing the occurrence of power to be sold. Thus, if the adjustment functions of the PCS 110 and the storage controller 210 independently operate at the same time, the system as a whole. could operate unstably. However, as described above, the HEMS 310 serves as a control tower and instructs the storage controller 210 to charge the storage battery 200 with surplus power, instead of transferring the output suppression instruction to the PCS 110 (instead of performing the suppression of the output of the power generation). Alternatively, the HEMS 310 instructs the storage controller 210 to charge the storage battery 200 with its maximum charge power (a certain value) (or instructs the storage controller 210 to charge the storage battery 200 with an arbitrary power value that does not depend on the power generated or instructing the storage controller 210 to stop the charging) and instructs the PCS 110 to perform the load following operation. In this way, the HEMS 310 can stabilize the overall system operation. Since the HEMS 310 allows only one of the adjustment functions to operate as described above, a significant advantageous effect of stabilizing the overall system operation can be obtained.

In the above exemplary embodiment, while the HEMS 310 checks the end of the suppression period, the HEMS 310 may be configured to notify the PCS 110 of the end of the suppression period when transferring the output suppression instruction to the PCS 110. In this case, the PCS 110 autonomously checks the end of the suppression period and ends the suppression control.

In the above exemplary embodiment, the HEMS 310 postpones the transfer timing of the output suppression instruction. However, if the output suppression instruction includes information about the start and end of the suppression control, the HEMS 310 may rewrite and transfer the information to the PCS 110. By allowing the PCS 110 to perform the suppression control in accordance with the rewritten output suppression instruction, the suppression period can be shortened, as in the above exemplary embodiment.

### Second Exemplary Embodiment

Next, a second exemplary embodiment will be described. In the second exemplary embodiment, the method of shortening the suppression implementation period is changed. The second exemplary embodiment has the same basic configuration as that according to the first exemplary embodiment. Since only the difference from the first exemplary embodiment is the operation of shortening the suppression implementation period performed by the HEMS 310, the following description will be made with a focus on the operational difference.

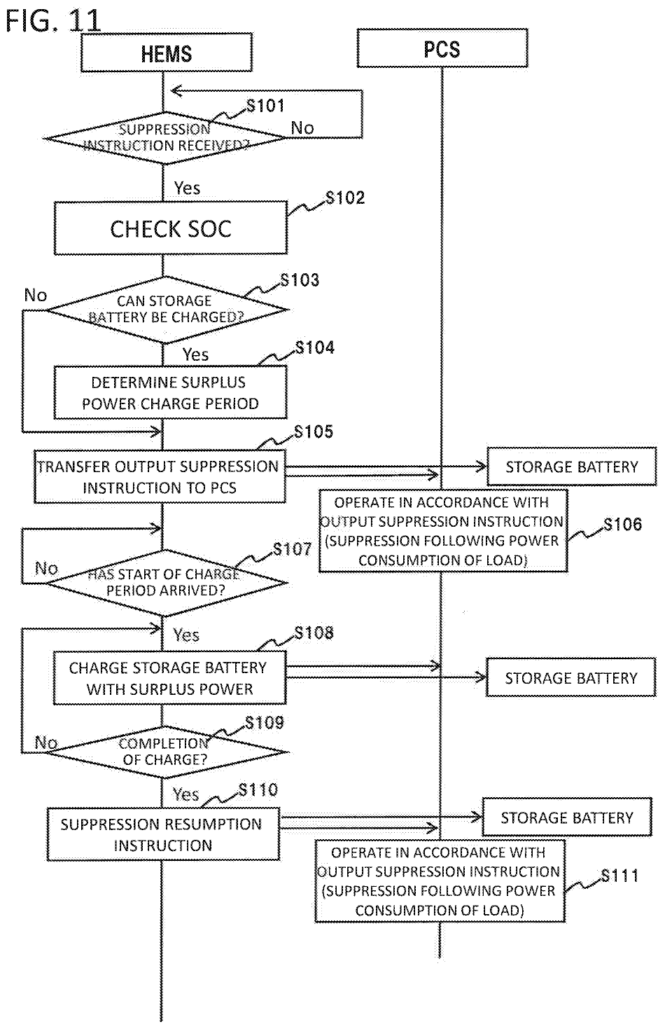

FIG. 11 is a sequence diagram illustrating an operation of the charge and discharge control system according to the second exemplary embodiment of the present disclosure. As illustrated in FIG. 11, first, if the HEMS 310 receives an output suppression instruction (Yes in step S101), the HEMS 310 checks the SOC of the storage battery 200 received from the storage controller 210 (step S102).

If, as a result of the checking, the HEMS 310 determines that the storage battery 200 can be charged (Yes in step S103), the HEMS 310 determines, of all the output suppression period specified by the output suppression instruction, a period (charge period) in which no suppression is performed and the storage battery 200 is charged with surplus power (step S104). The HEMS 310 may determine the charge period based on a preset period in which the surplus power is large or a period specified by a user.

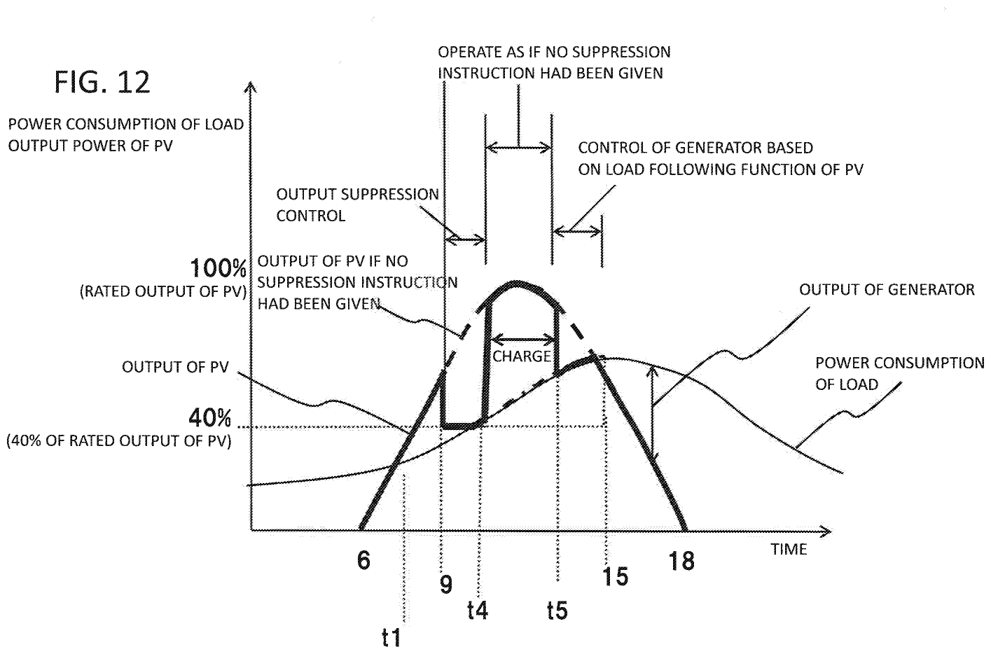

The following description assumes that the HEMS 310 has determined the period from time t4 to time t5 in which the surplus power is high as the charge period in the entire output suppression period from 9 o'clock to 15 o'clock, as illustrated in FIG. 12. In this case, the HEMS 310 transfers the output suppression instruction received in step S101 to the PCS 110, without postponing the transfer (step S105). If a function of controlling charging based on the surplus power of the power generation apparatus 100 is active in the storage battery 200, the HEMS 310 instructs the storage controller 210 to stop the function. The period in which the surplus power is high in the entire output suppression period may be determined in advance from actual measurement values obtained by measuring the output power of the power generation apparatus 100 or based on the output power predicted in advance from weather information or the like.

When receiving the output suppression instruction, the PCS 110 performs the output suppression control in accordance with the output suppression instruction. However, if the power consumption of the load equipment 400 exceeds the power generation amount in accordance with the output suppression instruction, the PCS 110 performs the output suppression control (load following function) that follows the power demand of the load equipment 400 (step S106).

The HEMS 310 checks whether the start of the charge period determined in step S104 has arrived (step S107). If, as a result of the checking, the HEMS 310 determines that the start of the charge period has arrived, the HEMS 310 instructs the PCS 110 to stop the suppression and instructs the storage controller 210 to start charging the storage battery 200 (step S108).

Thereafter, the HEMS 310 checks the SOC of the storage battery 200 (step S109). If the charge amount of the storage battery 200 indicates a predetermined threshold or more (Yes in step S109), the HEMS 310 instructs the PCS 110 to resume the output suppression and the storage controller 210 to end the charging (this is not necessary if the charging automatically ends when the charge amount indicates the predetermined threshold or more) (step S110).

When receiving the instruction, the PCS 110 resumes the output suppression control in accordance with the output suppression instruction. However, if the power consumption of the load equipment 400 exceeds the power generation amount in accordance with the output suppression instruction, the PCS 110 performs the output suppression control (load following function) that follows the power demand of the load equipment 400 (step S111). While the output suppression control end determination performed by the HEMS 310 is omitted in the example in FIG. 11, the same determination processing and suppression end processing as steps S009 and S010 in FIG. 10 (the first exemplary embodiment) may be added, as needed.

As described above, the present exemplary embodiment can provide an advantageous effect of performing charging in a period in which the surplus power is large, in addition to the advantageous effect provided by the first exemplary embodiment.

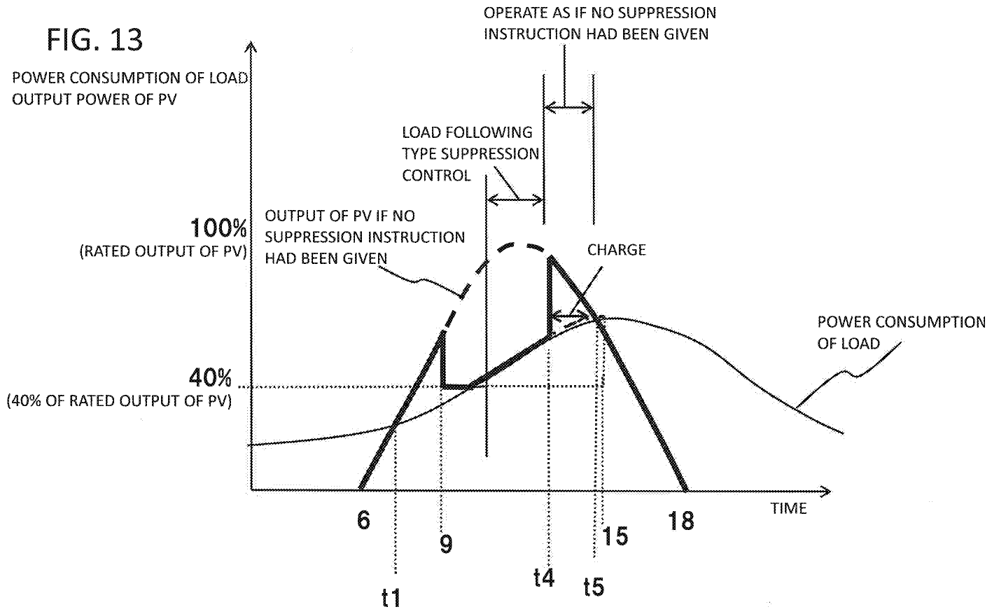

In the above exemplary embodiment, in the entire output suppression period, charging is performed in a period in which the surplus power is large. However, the charging may be performed in another period. The HEMS 310 may determine the charge period in view of various reasons. For example, as illustrated in FIG. 13, the storage battery 200 may be charged in the period from time t4 to time t5 later in the output suppression period. Likewise, as illustrated in FIG. 4, the storage battery 200 may be charged in the initial period from 9 o'clock to time t3 in the output suppression period. In addition, the user may receive a charge period, and the storage battery 200 may be charged in this period.

In addition, in the above exemplary embodiment, the HEMS 310 stops the output suppression to shorten the suppression implementation period. However, when the output suppression instruction includes information about the start and end of the suppression control, the HEMS 310 may be configured to first rewrite these items of information and next transmit the rewritten information to the PCS 110 and the storage controller 210 (namely, the HEMS 310 may have a function of creating an output suppression schedule and a charge schedule). The suppression implementation period can be shortened by causing the PCS 110 and the storage controller 210 to perform suppression control and charge control in accordance with the rewritten output suppression instruction, as in the above exemplary embodiment.

In addition, the HEMS 310 may determine a period in which the surplus power is large as the above charge period, by referring to the power balance represented by the difference between a thick dotted line (output of PV) and a thin solid line (power consumption of load) in FIG. 15. For example, as illustrated in FIG. 15, a HEMS 310a may be configured to include a power balance transition storage part 315 that stores transition of the power balance, and the charge and discharge control instruction part 312 may be configured to refer to the power balance transition storage part 315 when determining a charge period (a third exemplary embodiment). The power balance transition storage part 315 may be configured to hold various kinds of data about transition of the power balance such as about the previous day, the average per week, the average per month, the average per day, and the average per weather, and the HEMS 310a may determine a charge period based on any one of these kinds of data.

While exemplary embodiments of the present invention have thus been described, the present invention is not limited thereto. Further variations, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. Namely, the present invention is not limited to the configurations illustrated in the drawings.

In addition, in the above exemplary embodiment, when the power consumption of the load equipment 400 exceeds the power generation amount in accordance with the output suppression instruction, the PCS 110 increases the output of the power generation apparatus 100 by the excess, to supplement the power consumption of the load equipment 400 (the load following function). However, the HEMS 310 or an upper management apparatus may be configured to have the load following function. For example, the meter monitoring part 314 in the HEMS 310 in FIGS. 8 and 9 receives and supplies a surplus power value to the charge and discharge control instruction part 312. Thus, the HEMS 310 may be configured to transmit an output control value to the PCS via the PCS control part 313 so that the surplus power value indicates zero. Likewise, the HEMS 310 may be configured to transmit a charge power value of the storage battery 200 to the storage controller 210 so that the surplus power indicates zero.

In addition, the above exemplary embodiment has been described based on an example assuming that the power generation apparatus is a PV apparatus, the present invention is applicable in the same way to a power generation apparatus that generates power based on renewable energy such as wind power, water power, tidal power, geothermal power, or the like or to a configuration including a combination of these kinds of power.

In addition to the storage battery according to the above exemplary embodiment, a heat pump apparatus or the like may be connected. In this case, even after the storage battery 200 is fully charged, the heat pump apparatus (a water heater or the like) can collect thermal energy from the outside air by using all or part of the power to be suppressed and hold the collected thermal energy. In this way, the energy demand in the evening or the like can be met.

Finally, preferable modes of the present invention will be summarized.

### Mode 1

(See the charge and discharge control system according to the above first aspect)

### Mode 2

In the above charge and discharge control system, when the control part receives the power generation amount suppression instruction, if the free capacity of the storage battery is equal to or more than the predetermined value, the control part can shorten a suppression implementation period of the power generation apparatus and charge the storage battery in a period obtained by shortening the suppression implementation period.

### Mode 3

In the above charge and discharge control system, the control part can shorten the suppression implementation period of the power generation apparatus by postponing transfer timing of the received power generation amount suppression instruction to the power generation apparatus.

### Mode 4

In the above charge and discharge control system, when the control part receives the power generation amount suppression instruction, if the free capacity of the storage battery is equal to or more than the predetermined value, the control part can shorten the suppression implementation period of the power generation apparatus by determining a period in which the storage battery is charged and suppressing the power generation amount in a period other than the determined period.

### Mode 5

In the above charge and discharge control system, the control part can select a period in which the surplus power is large as the period in which the storage battery is charged.

### Mode 6

In the above charge and discharge control system, the power generation apparatus can have an output suppression function that uses the larger one of specified output power in accordance with the suppression instruction and power consumed by the load equipment in the suppression implementation period in accordance with the power generation amount suppression instruction as an upper limit.

### Mode 7

In the above charge and discharge control system, if the free capacity of the storage battery is equal to or more than the predetermined value, the power generation apparatus can suppress its output in such a manner that surplus power beyond maximum charge power of the storage battery indicates zero.

### Mode 8

(See the control apparatus according to the above second aspect)

### Mode 9

(See the charge and discharge control method according to the above third aspect)

### Mode 10

(See the program according to the above fourth aspect)

Modes 8 to 10 can be expanded in the same way as mode 1 is expanded to modes 2 to 7.

The disclosure of each of the above PTLs and NPLs is incorporated herein by reference thereto. Variations and adjustments of the exemplary embodiments and the examples are possible within the scope of the overall disclosure (including the claims) of the present invention and based on the basic technical concept of the present invention. Various combinations and selections (including partial deletion) of various disclosed elements (including the elements in the claims, exemplary embodiments, examples, drawings, etc.) are possible within the scope of the disclosure of the present invention. Namely, the present invention of course includes various variations and modifications that could be made by those skilled in the art according to the overall disclosure including the claims and the technical concept. Particularly, as to the numerical value ranges disclosed in the present application, even if the description does not particularly disclose arbitrary numerical values or small ranges included in the ranges, these values and ranges should be deemed to have been specifically disclosed.

### REFERENCE SIGNS LIST

100, 100a power generation apparatus
110 PCS (power conditioning system)
120 PV
200, 200a storage battery
210 storage controller
210a storage control apparatus
300, 300a control apparatus
310, 310a HEMS
311 system side apparatus communication part
312 charge and discharge control instruction part
313 PCS control part
314 meter monitoring part
315 power balance transition storage part
400 load equipment
500 power measurement apparatus

1. A charge and discharge control system, comprising:
a power generation apparatus that supplies power to load equipment or supplies surplus power to a system side;
a storage battery that is capable of accumulating surplus power from the power generation apparatus; and
a control part that receives a power generation amount suppression instruction and transfers the power generation amount suppression instruction to the power generation apparatus,
wherein, when the control part receives the power generation amount suppression instruction, if free capacity of the storage battery is less than a predetermined value, the control part transfers the power generation amount suppression instruction to the power generation apparatus.

2. The charge and discharge control system according to claim 1, wherein, when the control part receives the power generation amount suppression instruction, if the free capacity of the storage battery is equal to or more than the predetermined value, the control part shortens a suppression implementation period of the power generation apparatus and charges the storage battery in a period obtained by shortening the suppression implementation period.

3. The charge and discharge control system according to claim 2, wherein the control part shortens the suppression implementation period of the power generation apparatus by postponing transfer timing of the received power generation amount suppression instruction to the power generation apparatus.

4. The charge and discharge control system according to claim 1, wherein, when the control part receives the power generation amount suppression instruction, if the free capacity of the storage battery is equal to or more than the predetermined value, the control part shortens the suppression implementation period of the power generation apparatus by determining a period in which the storage battery is charged and suppressing the power generation amount in a period other than the determined period.

5. The charge and discharge control system according to claim 4, wherein the control part selects a period in which the surplus power is large as the period in which the storage battery is charged.

6. The charge and discharge control system according to claim 1, wherein the power generation apparatus has an output suppression function that uses the larger one of specified output power in accordance with the suppression instruction and power consumed by the load equipment in the suppression implementation period in accordance with the power generation amount suppression instruction as an upper limit.

7. The charge and discharge control system according to claim 1, wherein, if the free capacity of the storage battery is equal to or more than the predetermined value, the power generation apparatus suppresses its output in such a manner that surplus power beyond maximum charge power of the storage battery indicates zero.

8. A control apparatus, which is connected to a power generation apparatus that supplies power to load equipment or supplies surplus power to a system side and a storage battery that is capable of accumulating surplus power from the power generation apparatus, receives a power generation amount suppression instruction, and transfers the power generation amount suppression instruction to the power generation apparatus,
wherein, when the control part receives the power generation amount suppression instruction, if free capacity of the storage battery is less than a predetermined value, the control apparatus transfers the power generation amount suppression instruction to the power generation apparatus.

9. The control apparatus according to claim 8, wherein, when the control apparatus receives the power generation amount suppression instruction, if the free capacity of the storage battery is equal to or more than the predetermined value, the control apparatus shortens a suppression implementation period of the power generation apparatus and charges the storage battery in a period obtained by shortening the suppression implementation period.

10. The control apparatus according to claim 9, wherein, the control apparatus shortens the suppression implementation period of the power generation apparatus by postponing transfer timing of the received power generation amount suppression instruction to the power generation apparatus.

11. The control apparatus according to claim 8, wherein, when the control apparatus receives the power generation amount suppression instruction, if the free capacity of the storage battery is equal to or more than the predetermined value, the control apparatus shortens the suppression implementation period of the power generation apparatus by determining a period in which the storage battery is charged and suppressing the power generation amount in a period other than the determined period.

12. The control apparatus according to claim 11, wherein the control apparatus selects a period in which the surplus power is large as the period in which the storage battery is charged.

13. The control apparatus according to claim 8, wherein the power generation apparatus has an output suppression function that uses the larger one of specified output power in accordance with the suppression instruction and power consumed by the load equipment in the suppression implementation period in accordance with the power generation amount suppression instruction as an upper limit.

14. The control apparatus according to claim 8, wherein, if the free capacity of the storage battery is equal to or more than the predetermined value, the control apparatus suppresses an output of the power generation apparatus in such a manner that surplus power beyond maximum charge power of the storage battery indicates zero.

15. The control apparatus according to claim 8, wherein the control apparatus is arranged in the storage battery and serves as a charge control part that controls charge and discharge of the storage battery.

16. The control apparatus according to claim 8, wherein the control apparatus is arranged in the power generation apparatus and serves as a power conditioning system that controls an output of the power generation apparatus.

17. A charge and discharge control method, comprising:
causing a control part in a charge and discharge control system including a power generation apparatus that supplies power to load equipment or supplies surplus power to a system side, a storage battery that is capable of accumulating surplus power from the power generation apparatus, and the control part that receives a power generation amount suppression instruction and transfers the power generation amount suppression instruction to the power generation apparatus to receive the power generation amount suppression instruction; and
causing the control part to transfer, if free capacity of the storage battery is less than a predetermined value when the control part receives the power generation amount suppression instruction, the power generation amount suppression instruction to the power generation apparatus.

18. (canceled)

19. The control apparatus according to claim 9, wherein, when the control apparatus receives the power generation amount suppression instruction, if the free capacity of the storage battery is equal to or more than the predetermined value, the control apparatus shortens the suppression implementation period of the power generation apparatus by determining a period in which the storage battery is charged and suppressing the power generation amount in a period other than the determined period.

20. The control apparatus according to claim 10, wherein, when the control apparatus receives the power generation amount suppression instruction, if the free capacity of the storage battery is equal to or more than the predetermined value, the control apparatus shortens the suppression implementation period of the power generation apparatus by determining a period in which the storage battery is charged and suppressing the power generation amount in a period other than the determined period.

21. The control apparatus according to claim 9, wherein the power generation apparatus has an output suppression function that uses the larger one of specified output power in accordance with the suppression instruction and power consumed by the load equipment in the suppression implementation period in accordance with the power generation amount suppression instruction as an upper limit.
